(19) United States
(12) Patent Application Publication
(10) Pub. No.: US 2017/0321028 A1
(43) Pub. Date: Nov. 9, 2017

(54) SYSTEM AND METHOD FOR MAKING HIGH-DENSITY COVER BOARDS

(71) Applicant: JOHNS MANVILLE, Denver, CO (US)

(72) Inventor: Leah M. Dougherty, Evergreen, CO (US)

(21) Appl. No.: 15/149,359

(22) Filed: May 9, 2016

(51) Int. Cl. C08J 9/228; B29C 44/46; B29C 44/32; B29K 105/04; B29K 105/16; B29K 75/00

(52) U.S. Cl. CPC C08J 9/228; B29C 44/46; B29C 44/326; B29K 2105/16; B29K 2075/00; C08J 2205/00; C08J 2375/04; B29K 2105/04

(57) ABSTRACT

A high-density foam cover board, including a high-density foam layer, wherein the high-density foam layer comprise polyurethane, polyisocyanurate, a filler, and a viscosity additive.

### BACKGROUND OF THE INVENTION

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Commercial and industrial buildings typically have roofing systems with a metal deck (e.g., low-slope roof deck). These roofing systems usually have one or more layers of insulation that insulate the metal deck and one or more waterproofing layers that protect the insulation from moisture. For example, a roofing system may have one or more layers of low-density insulation, one or more cover boards on top of the low-density insulation, and one or more waterproofing layers on top of the cover boards. Unfortunately, the layer(s) of low-density insulation (e.g., low-density polymer-based foam insulation) can be partially crushed or otherwise damaged from worker traffic over the insulation, the placement of heavy objects on the insulation, and the weather (e.g., hail). By placing cover boards on top of the low-density insulation, the cover boards may protect the fragile low-density insulation from damage. The cover boards may also act as a fire barrier, provide additional insulation, and enable attachment of a waterproofing layer. While these roofing systems work well, it is desirable to reduce the cost of the cover boards.

### BRIEF SUMMARY OF THE INVENTION

The present disclosure is directed to a high-density foam cover board that includes a high-density foam layer. The high-density foam layer may include polyurethane, polyisocyanurate, a filler, and a viscosity additive.

An aspect of the disclosure includes a manufacturing system for making a foam cover board. The manufacturing system includes a first chemical line that delivers a first mixture to a mixing head. The first chemical line may include a first storage tank capable of storing polyol; a first mixer that mixes the polyol with one or more catalysts and a blowing agent; and a first pump fluidly coupled to the first mixer that pumps the first mixture to the mixing head. The manufacturing system may also include a second chemical line that delivers a second mixture to the mixing head. The second chemical line includes a second storage tank capable of storing isocyanate, and a second pump coupled to the second storage tank that pumps the isocyanate to the mixing head. A third storage tank in the manufacturing system stores a filler. In operation, the manufacturing system combines the filler, the first mixture, and the second mixture to form the foam cover board.

Another aspect of the disclosure includes a method of making a foam cover board with a filler. The method includes flowing a first mixture and a second mixture to a mixing head. The first mixture may include polyol and at least one catalyst. The second mixture includes isocyanate. The method then combines a filler with the first mixture and the second mixture to form a foam cover board.

### BRIEF DESCRIPTION OF THE DRAWINGS

Various features, aspects, and advantages of the present invention will be better understood when the following detailed description is read with reference to the accompanying figures in which like characters represent like parts throughout the figures, wherein:

FIG. 1 is a cross-sectional view of an embodiment of a high-density foam cover board with a filler;

FIG. 2 is a schematic view of an embodiment of a cover board manufacturing system that makes a high-density foam cover board with a filler;

FIG. 3 is a schematic view of an embodiment of a cover board manufacturing system that makes a high-density foam cover board with a filler;

FIG. 4 is a schematic view of an embodiment of a cover board manufacturing system that makes a high-density foam cover board with a filler;

FIG. 5 is a schematic view of an embodiment of a cover board manufacturing system that makes a high-density foam cover board with a filler; and

FIG. 6 is a schematic view of an embodiment of a cover board manufacturing system that makes a high-density foam cover board with a filler.

### DETAILED DESCRIPTION OF THE INVENTION

One or more specific embodiments of the present invention will be described below. These embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

The embodiments discussed below disclose a high-density foam cover board with one or more fillers (e.g., mineral fillers) and one or more viscosity modifiers. The fillers and viscosity modifiers may reduce the manufacturing costs of the high-density foam cover board. For example, the fillers may reduce the amount of petrochemicals, catalysts, etc. used during production. Moreover, the embodiments discussed below disclose a manufacturing system that enables production of cover boards with fillers and viscosity modifiers. As will be explained in detail, the manufacturing system may include chemical lines that form and/or carry mixtures. These mixtures are combined in a mixing head to form the cover boards. The fillers and viscosity modifiers may be added to one or more of the chemical lines and/or combined with the mixtures in the mixing head to form the cover board. In some embodiments, the manufacturing system may also include a control system that controls the manufacturing system to produce the cover boards.

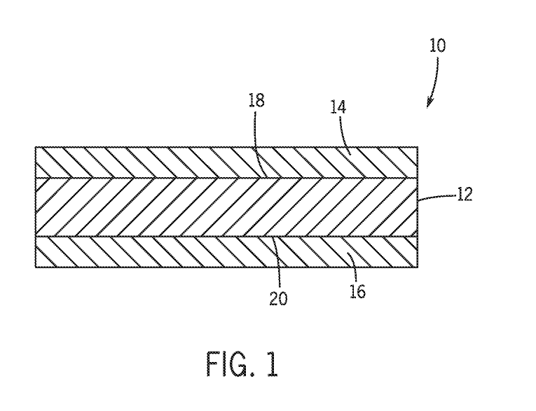

FIG. 1 is a cross-sectional view of an embodiment of a cover board 10 (e.g., high-density foam cover board) with fillers. In operation, the coverboard 10 protects the low-density insulation (e.g., low-density polymer-based foam insulation). In some embodiments, the high-density foam layers may have a density greater than three pounds per cubic foot in order to protect low-density insulation. As illustrated, the cover board 10 includes a foam layer 12 of high-density insulation. However, some embodiments may include one or more high-density foam layers 12 (e.g., 1, 2, 3, 4, 5, or more) that contain one or more fillers (e.g., mineral fillers) and one or more viscosity modifiers. The viscosity modifier(s) may be a non-volatile liquid with viscosities less than a thousand centipoise (cps). In some embodiments, the viscosity modifier(s) may have centipoise less than one hundred and have active hydroxyl groups. Examples of possible viscosity modifiers may include propylene glycol, diethylene glycol, polypropylene glycol, propylene carbonate, or a combination thereof. As will be explained below, the viscosity modifier(s) facilitate mixing of a filler(s) with the other components of the of the foam layer 12.

By including fillers and viscosity modifiers in the foam layer(s) 12, the foam layer(s) 12 may be produced more cheaply (e.g., using fewer petrochemicals, catalysts, etc.) while still maintaining strength, durability, etc. In operation, the viscosity modifiers enable higher filler inclusion in the coverboard formulation while still enabling manufacturing of the coverboards in traditional ways. The high density board produced by such formulation can have same or better compressive strength, flexural strength, wind uplift rating, and flame resistance. The fillers may include inorganic, organic powders, platelets, fibers, granules, or a combination thereof with particle sizes less than one hundred and fifty microns. In some embodiments, the particle size may be less than ten microns, which may facilitate mixing of the filler in the foam layer(s) 12 as well as homogeneity. Examples of fillers may include talc, kaolin, glass dust, mica, carbon black, magnesium hydroxide, gypsum, calcium carbonate, expanded perlite, glass fibers, or a combination thereof. In some embodiments, the layer(s) 12 may include up to 50%, 10-40%, 15-30% by weight of fillers. With an increase in the percentage by weight of fillers, the percentage by weight of viscosity modifiers may also increase. For example, the foam layer(s) 12 may include up to 10% by weight of a viscosity modifier(s). In other words, there may be a ratio between the amount of filler(s) and the corresponding amount of viscosity modifier(s). For example, the ratio may be 1% by weight of a viscosity modifier(s) to 4-7% by weight of a filler(s) in the layer(s) 12.

The foam layer 12 may also include multiple fillers at different concentrations and/or viscosity modifiers. For example, a foam layer 12 may include a first filler at 5% by weight, a second filler that is 5% by weight, and a third filler that is 10% by weight. In some embodiments, the foam layer 12 may include a single filler such as calcium carbonate with particles that are less than ten microns in diameter (e.g., less than 1, 2, 3, 4, 5, 6, 7, 8, 9, 10 microns in diameter) and that occupy up to 50% by weight of the foam layer 12.

As will be explained in detail below, the fillers and viscosity modifiers are mixed with an isocyanate and/or a polyol to form the high-density cover boards. Exemplary polyfunctional isocyanates that may form substituted or unsubstituted polyisocyanates that are used to make the polyisocyanurate foam boards and other foam products include aromatic, aliphatic, and cycloaliphatic polyisocyanates having at least two isocyanate functional groups. Exemplary aromatic polyfunctional isocyanates include: 4,4′-diphenylmethane diisocyanate (MDI), polymeric MDI (PMDI), toluene disisocyanate, and allophanate modified isocyanate. For example, the polyfunctional isocyanate may be PMDI with functionality between 2.3 to 3.0, viscosity less at 800 cps at 25° C., and isocyanate content between 28% to 35%.

The polyfunctional isocyanates may be reacted with a polyfunctional co-reactant that has at least two reactive groups that react with the polyfunctional isocyanate to produce a polyisocyanurate compounds for the present products. Exemplary polyfunctional co-reactants may include polyester and polyether polyols having at least 2 isocyanate reactive groups, such as hydroxyl groups. Specific examples include aromatic polyester polyols which have good mechanical properties, as well as hydrolytic and thermo-oxidative stability. Commercially available polyester polyol include those sold by Stepan Company under the name Stepanol® and those sold by Huntsman Corporation under the name of Terol®. Exemplary polyols may have a functionality between 2 and 2.5 and hydroxyl number between 150 mg KOH/gm and 450 mg KOH/gm.

The catalysts used to polymerize the polyisocyanurates may include amine catalysts and metal catalysts, among other catalysts. The amine catalysts catalyze both urethane reactions between isocyanates and polyols, and urea reactions between water and isocyanates. The metal catalysts may include metal carboxylate trimer catalysts, which promote the conversion of isocyanate to highly thermally stable isocyanurate ring. Examples of suitable amine catalysts include pentamethyldiethylenetriamine (PMDETA), dimethylcyclohexylamine, and 1, 3, 5-tris(3-(dimethylamino)propyl)-hexahydro-triazine. Examples of suitable metal catalysts include potassium octoate and potassium acetate.

The present polyisocyanurate formulations may also include one or more surfactants. The surfactants function to improve compatibility of the formulation components and stabilize the cell structure during foaming. Exemplary surfactants may include organic or silicone based materials. Typical silicone based surfactants may include polyether modified polysiloxane, such as commercially available DC193 surfactant from AirProducts, and Tergostab® series surfactants from Evonik, such as Tergostab® 8535.

The polyol typically includes either or both a polyether and polyester having a hydroxyl number between about 25 and 500, and more commonly between about 200 and 270. The hydroxyl number is a measure of the concentration of the hydroxyl group in the polyol, which is expressed as the milligrams of KOH (potassium hydroxide) equivalent to the hydroxyl groups in one gram of polyol. Polyether is commonly not used in conventional polyisocyanurate foam boards because it is typically less flame resistant than the aromatic polyester that is used in such boards. A lower hydroxyl number commonly results in longer polymer chains and/or less cross linking, which results in a relatively loose polymer chain. In contrast, a higher hydroxyl number commonly results in more cross linking and/or shorter polymer chains, which may enhance mechanical properties and/or flame resistance.

The polyisocyanurate core 102 has an isocyanate index greater than about 180, commonly between about 180 and 360, and more commonly between about 200 and 300. When isocyanate reacts with one or more polyols to form polyurethane, one NCO group reacts with one OH group. As is known in the art, the index is defined as the ratio of NCO group to OH group multiplied by 100 as shown in the formula below:

$$Index = \frac{Moles of NCO group}{Moles of OH group} \times 100$$

When the number of NCO group equals the number of OH group in a formulation, a stoichiometric NCO:OH ratio of 1.0 is realized and a polyurethane polymer/foam is produced. When the number of NCO groups is significantly more than the number of OH groups in a formulation, the excess isocyanate group reacts with itself under catalytic condition to form isocyanurate linkage and polyisocyanurate foam is produced. The above described isocyanate index, and especially an index of between about 250 and 400, provides at least a 2:1 ratio of NCO groups to OH groups, which has been found to provide an appreciable combination of structure integrity, thermal strength and/or stability, and fire resistance. In some embodiments, the isocyanate index may be between 250-300.

In addition to, filler, viscosity modifiers, and isocynate the foam layers may include other substances. As illustrated below, Table 1 details the substances that form part of the foam layer(s) 12 and their ranges in percent by weight of the overall foam layer(s) 12.

TABLE 1

| Substance | Min. Percent by Weight | Max. Percent by Weight |
|---|---|---|
| Polyol | 5% | 45% |
| Viscosity Modifier | 0% | 10% |
| Surfactant | 0% | 2% |
| Amine Catalyst | 0% | 0.5% |
| Potassium Octoate | 0% | 2% |
| Potassium Acetate | 0% | 0.5% |
| Filler(s) | 0% | 50% |
| Water | 0% | 0.5% |
| Pentane | 1% | 4% |
| Isocyanate | 25% | 75% |

In some embodiments, the cover board 10 may include additional layers 14 and 16 that couple to the one or more foam layers 12. These layers 14 and 16 may be protective layers that protect the foam layer 12 by blocking mold and mildew grow, as well as repelling water. For example, the layers 14 and 16 may be coated glass facers (CGF). The layers 14 and 16 couple to respective opposite faces 18 and 20 of the foam layer 12. In some embodiments, the cover board 10 may include only one protective layer either layer 14 or 16.

As illustrated in Table 2 below, coverboards made with a filler(s) and a viscosity modifier(s) perform as well as coverboards without. Indeed, the differences in compressive strength between the two types of coverboards is statistically insignificant. However, producing coverboards with a filler(s) and a viscosity modifier(s) may reduce the manufacturing costs of coverboards.

TABLE 2

| | | Foam Density | | Compressive Strength | |
|---|---|---|---|---|---|
| | Polyol Mix | (lbs per cubic foot) | | (PSI) | |
| | Viscosity | | Standard | | Standard |
| | (cps) | Average | Deviation | Average | Deviation |
| 0% Filler | 3585 | 6.6 | 0.33 | 89.55 | 18.3 |
| (control) | | | | | |
| 15% Filler | 3403 | 6.2 | 0.51 | 84.08 | 13.9 |

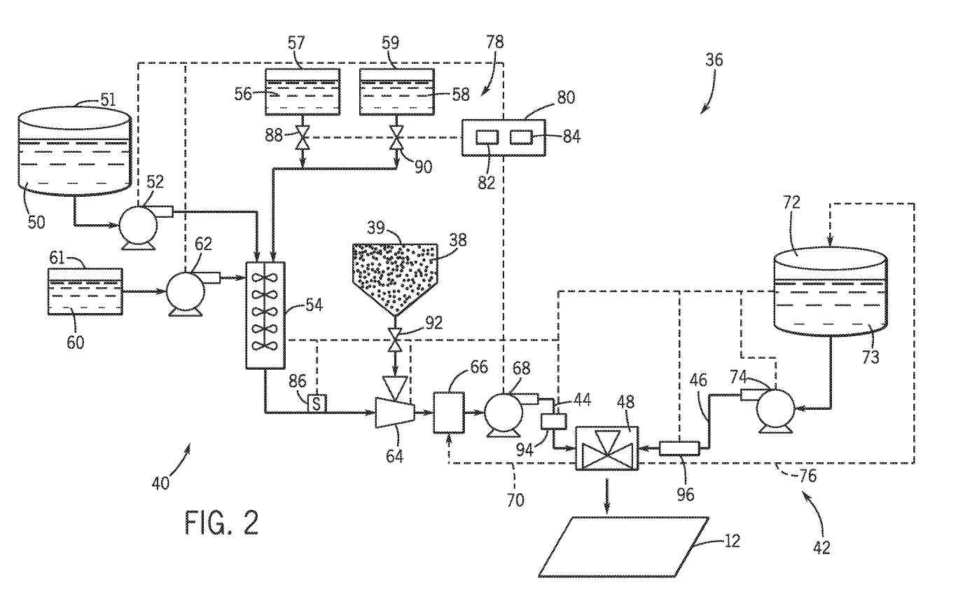

FIG. 2 is a schematic view of an embodiment of a cover board manufacturing system 36 that makes a cover board 10 with a filler 38 stored in a storage tank or filler source 39. As will be explained below, the manufacturing system 36 may include a first chemical line 40 and a second chemical line 42. The first chemical line 40 forms a first mixture 44 and the second chemical line 42 either forms or carries a second chemical mixture 46 to a mixing head 48. At the mixing head 48, the manufacturing system 36 combines the first and second chemical mixtures 44, 46, enabling the first and second mixtures 44, 46 to chemically react and form the foam layer 12.

The first chemical line 40 forms the first mixture 44, by pumping polyol 50 from a storage tank or polyol source 51 with a pump 52 into a mixer 54 (e.g., dynamic mixer). In the mixer the polyol 50 is combined with one or more catalysts 56 (e.g., potassium octoate, potassium acetate, amine, surfactants, etc.) from a catalyst source 57 and a reactive viscosity additive 58 (e.g., propylene glycol, diethylene glycol, polypropylene glycol, propylene carbonate) from a viscosity additive source 59 that reduces the viscosity of the first mixture 44. As will be explained below, when the filler 38 is added to the first mixture 44 the viscosity increases. By including the viscosity additive 58 the manufacturing system 36 is able to maintain a desired viscosity of the first mixture 44 with the added filler 38. In some embodiments, the viscosity additive 58 (e.g., propylene glycol, diethylene glycol, polypropylene glycol, etc.) may be selected to increase adhesion between the foam layer 12 and additional layers (e.g., layers 14, 16). In other words, the viscosity additive 58 may compensate for a possible reduction in adhesion between the foam layer 12 and additional layers (e.g., layers 12, 14, 16) when filler 38 is added to the foam layer 12.

As the polyol 50, catalysts 56, and viscosity additive 58 mix in the mixer 54, a blowing agent 60 from a blowing agent source 61 is pumped into the mixer 54 with a pump 62. For example, the blowing agent 60 may be water mixed with pentane. During the chemical reaction between the first mixture 44 and the second mixture 46 the blowing agent 60 evaporates forming bubbles in the foam layer 12, which increases the insulative properties of the foam layer 12.

After exiting the mixer 54, the polyol 50, catalysts 56, viscosity additive 58, and blowing agent 60 enter a mixer 64 (e.g., solid-liquid mixer, eductor mixer) where filler 38 is added. As the filler 38 combines with the polyol 50, catalysts 56, viscosity additive 58, and blowing agent 60, the filler 38 increases the viscosity of the first mixture 44, which compensates for the previously added viscosity additive 58. In some embodiments, the filler 38 may be talc, kaolin, glass dust, mica, carbon black, magnesium hydroxide, gypsum, calcium carbonate, expanded perlite, glass fibers, or a combination thereof.

The first mixture 44 may then enter a tank 66 (e.g., a surge tank) that compensates for variations in the production process. For example, the manufacturing system 36 may include a return line 70 that redirects excess amounts of the first mixture 44 from the mixing head 48 to the tank 66 (e.g., during shutdown of the manufacturing system 36). From the tank 66, the first mixture 44 is pumped with a pump 68 to the mixing head 48. As the pump 68 pumps the first mixture 44 into the mixing head 48, the second chemical line 42 pumps a second mixture 46 (e.g., isocyanate 73) into the mixing head 48 using the pump 74. The first and second mixtures 44, 46 are then combined and discharged from the mixing head 48 to form the foam layer 12. As explained above, when the first and second mixtures 44 and 46 combine they chemically react to form the foam layer 12 (e.g., polyurethane, polyisocyanurate, and one or more fillers). The foam layer 12 may then be combined with additional layers (e.g., layers 12, 14, 16). In some embodiments, the manufacturing system 36 may include a return line 76 that returns excess second mixture 46 to the storage tank or isocyanate source 72 (e.g., during shutdown).

In order to control the manufacturing system 36, the manufacturing system 36 may include a control system 78. The control system 78 includes a controller 80 with one or more processors 82 that execute instructions stored on one or more memories 84 to control various components (e.g., pumps, mixers, valves, etc.) that form part of the first and second chemical lines 40, 42 using feedback from sensors and/or flowmeters.

For example, the manufacturing system 36 may include one or sensors 86 that monitor the mixing of the polyol 50, catalysts 56, viscosity additive 58, and blowing agent 60 and/or whether the polyol 50, catalysts 56, viscosity additive 58, and blowing agent 60 are within threshold ratios. If the proportions of polyol 50 and/or blowing agent 60 are outside of a threshold range, the controller 80 executes instructions with the processor 82 to increase and/or decrease the flow of the blowing agent 60 and/or polyol 50 using the pumps 52 and 62. Likewise, if the amounts of the catalysts 56 and/or viscosity additive 58 are outside of a threshold range, the controller 80 may execute instructions to control valves 88 and/or 90 to increase and/or decrease the amount of catalysts 56 and/or viscosity additive 58 entering the mixer 54.

Based on the measured amounts of polyol 50, catalysts 56, viscosity additive 58, and blowing agent 60, the controller 80 may control the amount of filler 38 that enters the mixer 64. For example, the controller 80 may control a valve 92 to increase and decrease the amount of filler 38 that enters the mixer 64. In some embodiments, the control system 78 may include a level sensor that detects the percentages of liquid and filler in the first mixture 44 to ensure the desired ratio of polyol 50, catalysts 56, viscosity additive 58 to filler 38 in the first mixture 44.

In order to control the ratio of the first mixture 44 to the second mixture 46 in the mixing head 48, the control system 78 may include flow meters 94, 96. As illustrated, the flow meter 94 enables measurement of the first mixture 44 entering the mixing head 48 and the flow meter 96 enables measurement of the second mixture 46 entering the mixing head 48. In operation, the controller 80 communicates with the flow meters 94, 96 and controls the pumps 68 and 74 in response to measured flow rates to ensure that the ratio of the first and second mixtures 44, 46 mix in the mixing head 48 within threshold ratios.

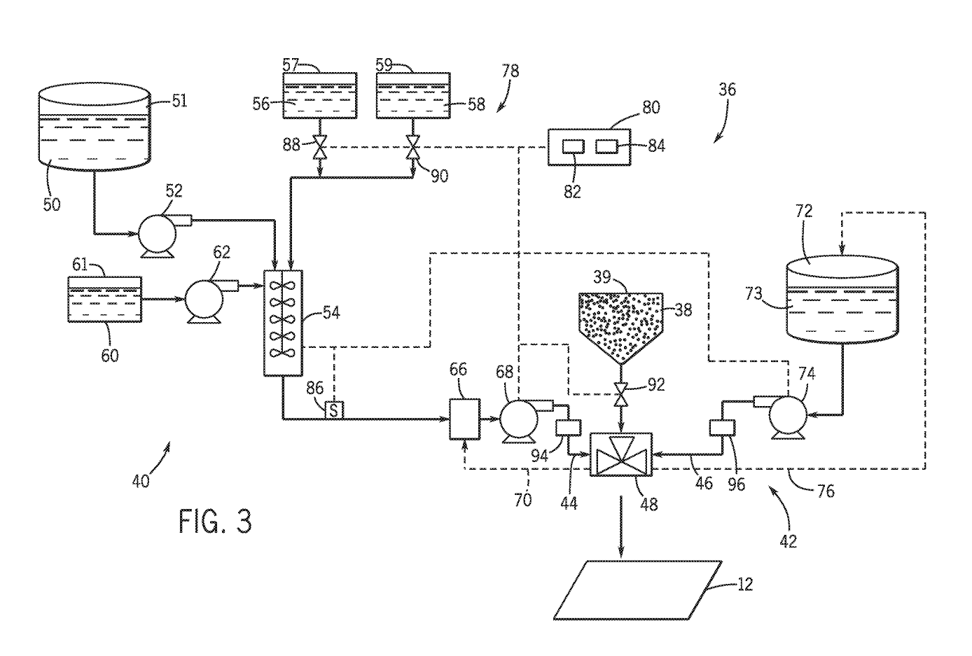

FIG. 3 is a schematic view of an embodiment of a manufacturing system 36 that makes a high-density foam cover board 10 that contains a filler 38. As explained above, the manufacturing system 36 includes a first chemical line 40 and a second chemical line 42. The first chemical line 40 forms a first mixture 44 and the second chemical line 42 either forms or carries a second chemical mixture 46 to a mixing head 48. At the mixing head 48, the manufacturing system 36 combines the first and second chemical mixtures 44, 46. However, instead of adding a filler 38 to the first and/or second mixtures 44, 46 before the first or second mixtures 44, 46 enter the mixing head 48, the manufacturing system 36 may combine the filler 38 with the first and second mixtures 44, 46 in the mixing head 48.

As illustrated, the manufacturing system 36 may also include a control system 78 that controls the manufacturing system 36. The control system 78 includes a controller 80 with one or more processors 82 that execute instructions stored on one or more memories 84 to control various components (e.g., pumps, mixers, valves, etc.) that form part of the first and second chemical lines 40, 42. In operation, the controller 80 may receive feedback from sensors and/or flowmeters to control formation and mixing of the first mixture, the second mixture, and filler 38 in the mixing head 48

For example, the manufacturing system 36 may include one or sensors 86 that monitor mixing of the polyol 50, catalysts 56, viscosity additive 58, blowing agent 60 and/or whether the polyol 50, catalysts 56, viscosity additive 58, blowing agent 60 are within a threshold ratios. If the ratios of the mixture components (e.g., polyol 50, catalysts 56, viscosity additive 58, and blowing agent 60) are outside of the threshold range the controller 80 executes instructions with the processor 82 to increase and/or decrease the flow of the different mixture components. For example, if the amounts of the catalysts 56 and/or viscosity additive 58 are outside the threshold range, the controller 80 may execute instructions to control the valves 88 and/or 90 to increase and/or decrease the amount of catalysts 56 and/or viscosity additive 58 entering the mixer 54. Similarly, the controller 80 may control the pumps 52 and 62 to increase and/or decrease the flow of the polyol 50 and blowing agent 60.

Based on the measured amounts of polyol 50, catalysts 56, viscosity additive 58, and blowing agent 60, the controller 80 may control the amount of filler 38 that enters the mixing head 48. For example, the controller 80 may control a valve 92 to increase and decrease the amount of filler 38 that enters the mixing head 48. In order to control the ratio of the first mixture 44 to the second mixture 46 in the mixing head 48, the control system 78 may include flow meters 94, 96. As explained above, the flow meter 94 enables measurement of the first mixture 44 entering the mixing head 48 and the flow meter 96 enables measurement of the second mixture 46 entering the mixing head 48. In operation, the controller 80 communicates with the flow meters 94, 96 and controls the pumps 68 and 74 in response to the measured flow rates to ensure that the desired amounts of the first and second mixtures 44, 46 mix in the mixing head 48.

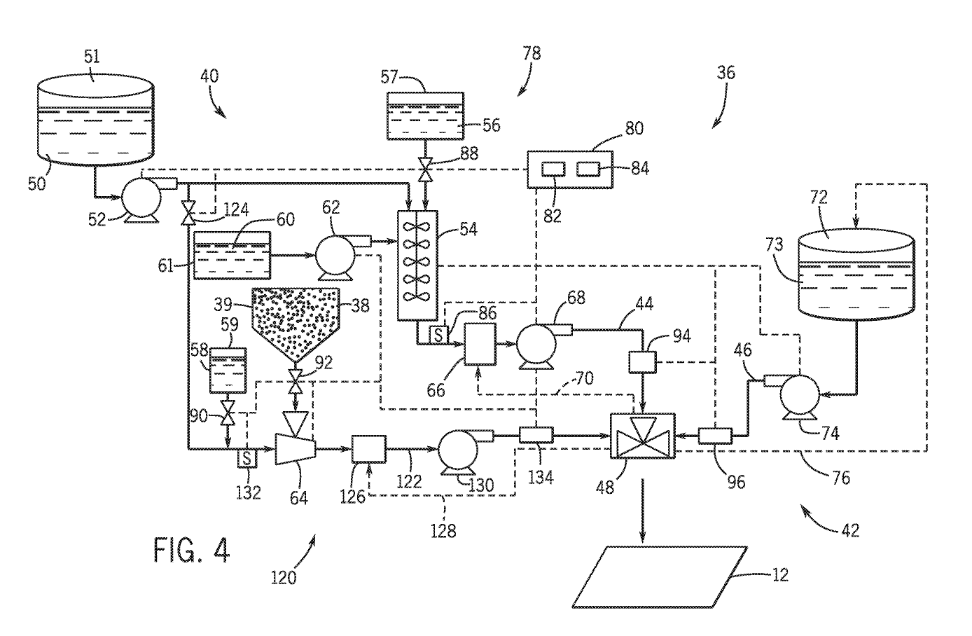

FIG. 4 is a schematic view of an embodiment of a cover board manufacturing system 36 that makes a cover board 10 with a filler 38. As illustrated, the manufacturing system 36 may include a first chemical line 40, a second chemical line 42, and a third chemical line 120. Each of the chemical lines 40, 42, and 120 carry a respective first mixture 44, a second mixture 46, and a third mixture 122. At the mixing head 48, the manufacturing system 36 combines the first, second, and third chemical mixtures 44, 46, 122 to form the foam layer 12.

The first chemical line 40 forms the first mixture 44, by pumping polyol 50 from a storage tank or polyol source 51 with a pump 52 into a mixer 54 (e.g., dynamic mixer). In the mixer, the polyol 50 is combined with one or more catalysts 56 (e.g., potassium octoate, potassium acetate, amine, surfactants, etc.). As the polyol 50 and catalysts 56 mix in the mixer 54, a blowing agent 60 is pumped into the mixer 54 with a pump 62. The blowing agent 60 may be a water mixed with pentane. During the chemical reaction between the first mixture 44, the second mixture 46, and the third mixture 122 the blowing agent 60 evaporates forming bubbles in the foam layer 12, which increases the insulative properties of the foam layer 12. After exiting the mixer 54, the first mixture 44 is pumped into the mixing head 48 with the pump 68 where it mixes with the second mixture 46 and the third mixture 122.

The third chemical line 120 forms the third mixture 122 by opening valve 124 to receive a portion of the polyol 50 pumped by the pump 52. The polyol 50 may then be combined with a viscosity additive 58 (e.g., propylene glycol, diethylene glycol, polypropylene glycol, propylene carbonate) that reduces the viscosity of the third mixture 122. As explained above, the filler 38 increases viscosity. By including the viscosity additive 58 the manufacturing system 36 is able to maintain a desired viscosity of the third mixture 122 with the filler 38. In some embodiments, the viscosity additive 58 (e.g., propylene glycol, diethylene glycol, polypropylene glycol, propylene carbonate) may be selected to increase adhesion between the foam layer 12 and additional layers (e.g., layers 12, 14, 16). In other words, the viscosity additive 58 may compensate for a possible reduction in adhesion between the foam layer 12 and additional layers (e.g., layers 12, 14, 16) when filler 38 is added to the foam layer 12.

The polyol 50 with the viscosity additive 58 then enter the mixer 64 (e.g., solid-liquid mixer, eductor mixer) where filler 38 is added. As the filler 38 combines, with the polyol 50 and viscosity additive 58 in the mixer 64, the filler 38 increases the viscosity, which compensates for the previously added viscosity additive 58. In some embodiments, the filler 38 may be talc, kaolin, glass dust, mica, carbon black, magnesium hydroxide, gypsum, calcium carbonate, expanded perlite, glass fibers, or a combination thereof.

After exiting the mixer 64, the third mixture 122 may then enter a tank 126 (e.g., a surge tank) that compensates for variations in the production process. For example, the manufacturing system 36 may include a return line 128 that redirects excess amounts of the third mixture 122 from the mixing head 48 to the tank 126. From the tank 126, the third mixture 122 is pumped with a pump 130 to the mixing head 48. When the first mixture 44, the second mixture 46, and the third mixture 122 combine, they react to form the foam layer 12 (e.g., polyurethane, polyisocyanurate, and one or more fillers). The foam layer 12 may then be combined with additional layers (e.g., layers 12, 14, 16).

In some embodiments, the manufacturing system 36 may include a control system 78 that controls the manufacturing system 36. The control system 78 includes a controller 80 with one or more processors 82 that execute instructions stored on one or more memories 84 to control various components (e.g., pumps, mixers, valves, etc.) that form part of the first, second, and third chemical lines 40, 42, 120. For example, the manufacturing system 36 may include a sensor 86 that monitors whether the polyol 50, catalysts 56, blowing agent 60 are within threshold ratios. If the proportions of the chemicals (e.g., polyol 50, catalysts 56, blowing agent 60) are outside the threshold ratios the controller 80 executes instructions with the processor 82 to increase and/or decrease the flow of the blowing agent 60 and the polyol 50 with the pumps 52, 62 and/or control one or more valves 88 to increase and/or decrease the amount of the catalysts 56 entering the mixer 54.

Similarly, the third chemical line 120 may include a sensor 132 that monitors whether the third mixture 122 includes the desired ratio of polyol 50 and the viscosity additive 58. Based on the measured amounts of polyol 50 and viscosity additive 58, the controller 80 may control the amount of filler 38 that enters the mixer 64. For example, the controller 80 may control a valve 92 to increase and decrease the amount of filler 38 that enters the mixer 64. In some embodiments, the control system 78 may include a level sensor that detects the ratio of liquid to filler in the third mixture 122 to ensure the desired ratio of polyol 50, viscosity additive 58, and filler 38.

In order to control the ratio of the first mixture 44, the second mixture 46, and the third mixture 122 in the mixing head 48, the control system 78 may include flow meters 94, 96, and 134. As illustrated, the flow meter 94 enables measurement of the first mixture 44 entering the mixing head 48, the flow meter 96 enables measurement of the second mixture 46 entering the mixing head 48, and the flow meter 134 enables measurement of the third mixture 122 entering the mixing head 48. In operation, the controller 80 controls the pumps 68, 74, 130 in response to measured flow rates from the flow meters 94, 96, and 134.

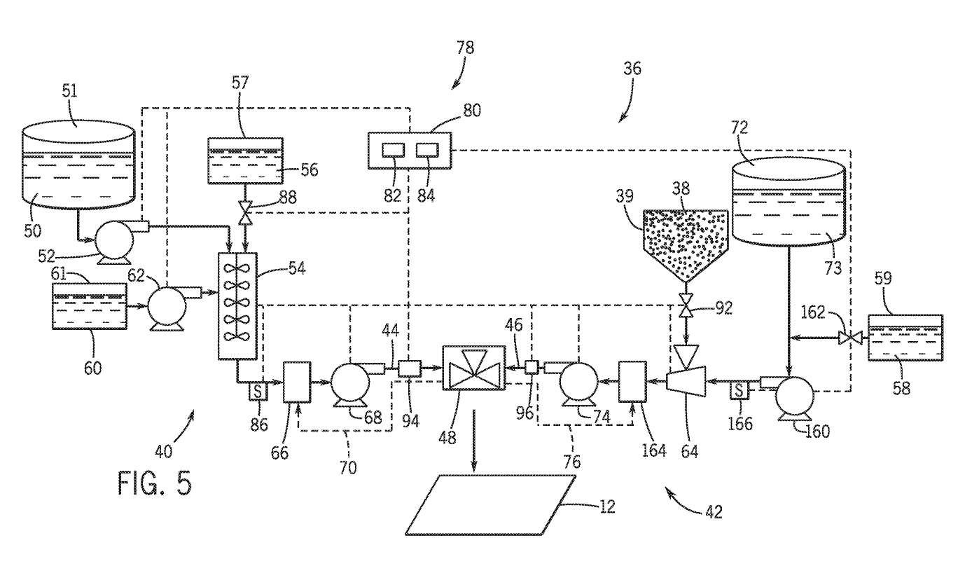

FIG. 5 is a schematic view of an embodiment of a manufacturing system 36 that makes a high-density foam cover board 10 that contains a filler 38. As explained above, the manufacturing system 36 may include a first chemical line 40 and a second chemical line 42 that form respective first and second chemical mixtures 44, 46. At the mixing head 48, the manufacturing system 36 combines the first and second chemical mixtures 44, 46. However, instead of adding filler 38 to the first mixture 44 the manufacturing system 36 may add filler 38 to the second mixture 46.

The first chemical line 40 forms the first mixture 44, by pumping polyol 50 from a storage tank or polyol source 51 with a pump 52 into a mixer 54 (e.g., dynamic mixer). In the mixer 54, the polyol 50 is combined with one or more catalysts 56 (e.g., potassium octoate, potassium acetate, amine, surfactants, etc.). As the polyol 50 and catalysts 56 mix in the mixer 54, a blowing agent 60 is pumped into the mixer 54 with a pump 62. The blowing agent 60 may be water mixed with pentane.

The first mixture 44 may then enter a tank 66 (e.g., a surge tank) that compensates for variations in the production process. For example, the manufacturing system 36 may include a return line 70 that redirects excess amounts of the first mixture 44 from the mixing head 48 to the tank 66. From the tank 66, the first mixture 44 is pumped with a pump 68 to the mixing head 48.

The second chemical line 42 forms the second mixture 46, by pumping isocyanate 73 from the storage tank or isocyanate source 72 into a mixer 64 (e.g., solid-liquid mixer, eductor mixer) with the pump 160. In the mixer 64 the isocyanate 73 combines with a filler 38. In order to compensate for the increase in viscosity by adding filler 38 into the second mixture 46, the second chemical line 42 may add a viscosity additive 58 (e.g., propylene glycol, diethylene glycol, polypropylene glycol, propylene carbonate) that reduces the viscosity of the second mixture 46. By including the viscosity additive 58, the manufacturing system 36 is able to maintain a desired viscosity of the second mixture 46 for later combination with the first mixture 44. As illustrated, the viscosity additive 58 may be added to the second chemical line 42 through a valve 162. In some embodiments, the viscosity additive 58 may be injected at other points along the second chemical line 42 and/or into the storage tank 72.

The second mixture 46 may then enter a tank 164 (e.g., a surge tank) that compensates for variations in the production process. For example, the manufacturing system 36 may include a return line 76 that redirects excess amounts of the second mixture 46 from the mixing head 48 to the tank 164. From the tank 164, the second mixture 46 is pumped with a pump 74 to the mixing head 48.

In the mixing head 48 the first and second mixtures 44, 46 are combined to form the foam layer 12. As explained above, when the first and second mixtures 44 and 46 combine they react to form the foam layer 12 (e.g., polyurethane, polyisocyanurate, and one or more fillers). The foam layer 12 may then be combined with additional layers (e.g., layers 12, 14, 16).

In some embodiments, the manufacturing system 36 may include a control system 78 that controls the manufacturing system 36. The control system 78 includes a controller 80 with one or more processors 82 that execute instructions stored on one or more memories 84 to control various components (e.g., pumps, mixers, valves, etc.) that form part of the first and second chemical lines 40, 42. In operation, the controller 80 may receive feedback from sensors and/or flowmeters to control formation and mixing of the first and second mixtures 44, 46.

For example, the manufacturing system 36 may include one or sensors 86 on the first chemical line 40 that monitor mixing of the polyol 50, catalysts 56, and blowing agent 60 as well as whether the polyol 50, catalysts 56, and blowing agent 60 are within threshold ratios. If the ratios of the chemicals (e.g., polyol 50, catalysts 56, blowing agent 60) are outside of the threshold ratios the controller 80 executes instructions with the processor 82 to increase and/or decrease the flow of the blowing agent 60, polyol 50, and catalysts 56 by controlling the pump 52, pump 62, and the one or more valve 88.

The second chemical line 42 may also include one or more sensors 166 that measure the amount of isocyanate 73 and viscosity additive 58 in the second mixture 46. If the ratios of isocyanate 73 and viscosity additive 58 are outside threshold ranges, the controller 80 executes instructions with the processor 82 to increase and/or decrease the flow of the isocyanate 73 with the pump 160 and/or controls the valve 162 to increase and/or decrease the amount of viscosity additive 58 entering the mixer 64. Based on the measured amounts of isocyanate 73 and viscosity additive 58, the controller 80 controls the amount of filler 38 that enters the mixer 64. As illustrated, the controller 80 may control a valve 92 to increase and/or decrease the amount of filler 38 that enters the mixer 64. In some embodiments, the control system 78 may include a level sensor that detects the percentages of liquid and filler in the second mixture 46 to ensure the desired ratio of isocyanate 73, viscosity additive 58, and filler 38 in the second mixture 46.

In some embodiments, the manufacturing system 36 may control the ratio of the first mixture 44 to the second mixture 46 in the mixing head 48 using flow meters 94, 96. As illustrated, the flow meter 94 enables measurement of the first mixture 44 entering the mixing head 48 and the flow meter 96 enables measurement of the second mixture 46 entering the mixing head 48. In operation, the controller 80 communicates with the flow meters 94, 96 and controls the pumps 68 and 74 in response to measured flow rates of the first and second mixtures 44, 46 entering the mixing head 48.

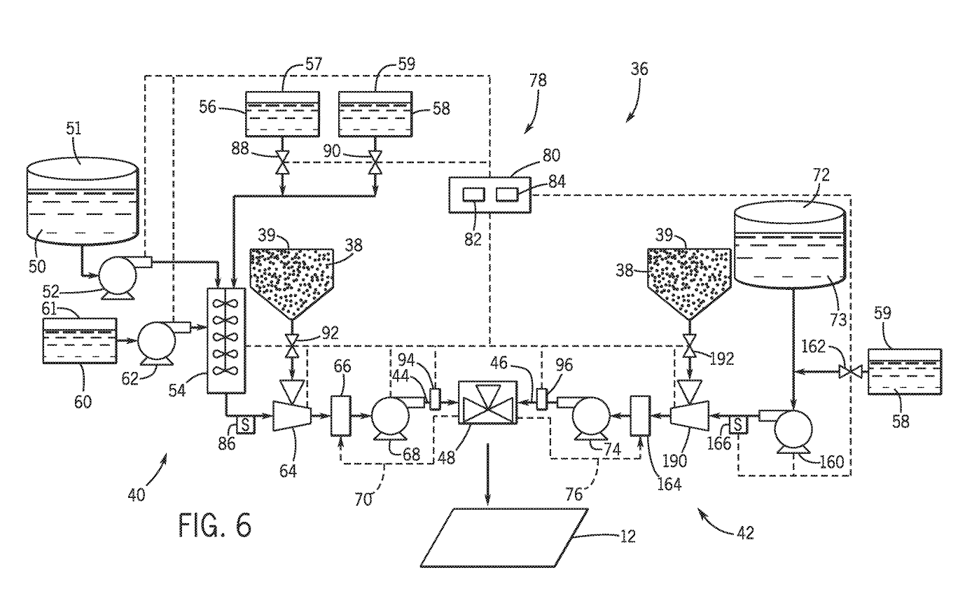

FIG. 6 is a schematic view of an embodiment of a manufacturing system 36 that makes a cover board 10 that contains a filler 38. The manufacturing system 36 includes a first chemical line 40 and a second chemical line 42. The first chemical line 40 forms a first mixture 44 and the second chemical line 42 forms a second chemical mixture 46. At the mixing head 48, the manufacturing system 36 combines the first and second chemical mixtures 44, 46, enabling the first and second mixtures 44, 46 to chemically react and form the foam layer 12.

The first chemical line 40 forms the first mixture 44, by pumping polyol 50 from a storage tank or polyol source 51 with a pump 52 into a mixer 54 (e.g., dynamic mixer). In the mixer the polyol 50 is combined with one or more catalysts 56 (e.g., potassium octoate, potassium acetate, amine, surfactants) and a viscosity additive 58 (e.g., propylene glycol, diethylene glycol, polypropylene glycol, propylene carbonate) that reduces the viscosity of the first mixture 44.

As the polyol 50, catalysts 56, and viscosity additive 58 mix in the mixer 54, a blowing agent 60 is pumped into the mixer 54 with a pump 62. During the chemical reaction between the first mixture 44 and the second mixture 46 the blowing agent 60 evaporates forming bubbles in the foam layer 12, which increases the insulative properties of the foam layer 12.

After exiting the mixer 54, the polyol 50, catalysts 56, viscosity additive 58, and blowing agent 60 enter a mixer 64 (e.g., solid-liquid mixer, eductor mixer) where filler 38 is added. As the filler 38 combines, with the polyol 50, catalysts 56, viscosity additive 58, and blowing agent 60, the filler 38 increases the viscosity the viscosity of the first mixture 44, which compensates for the previously added viscosity additive 58. In some embodiments, the filler 38 may be talc, kaolin, glass dust, mica, carbon black, magnesium hydroxide, gypsum, calcium carbonate, expanded perlite, glass fibers, or a combination thereof.

The first mixture 44 may then enter a tank 66 (e.g., a surge tank) that compensates for variations in the production process. For example, the manufacturing system 36 may include a return line 70 that redirects excess amounts of the first mixture 44 from the mixing head 48 to the tank 66. From the tank 66, the first mixture 44 is pumped with a pump 68 to the mixing head 48.

The second chemical line 42 forms the second mixture 46, by pumping isocyanate 73 from the storage tank or isocyanate source 72 into a mixer 190 (e.g., solid-liquid mixer, eductor mixer) with the pump 160. In the mixer 64 the isocyanate 73 combines with a filler 38. In order to compensate for the increase in viscosity by adding filler 38 into the second mixture 46, the second chemical line 42 may add a viscosity additive 58 (e.g., propylene glycol, diethylene glycol, polypropylene glycol, propylene carbonate) that reduces the viscosity of the second mixture 46. As illustrated, the viscosity additive 58 may be added to second chemical line 42 through a valve 162. In some embodiments, the viscosity additive 58 may also be injected at other points along the second chemical line 42 including into the isocyanate source 72.

The second mixture 46 may then enter a tank 164 (e.g., a surge tank) that compensates for variations in the production process. For example, the manufacturing system 36 may include a return line 76 that redirects excess amounts of the second mixture 46 from the mixing head 48 to the tank 164. From the tank 164, the second mixture 46 is pumped with a pump 74 to the mixing head 48.

In the mixing head 48, the first and second mixtures 44, 46 are combined and then discharged to form the foam layer 12. As explained above, when the first and second mixtures 44 and 46 combine they react to form the foam layer 12 (e.g., polyurethane, polyisocyanurate, and one or more fillers). The foam layer 12 may then be combined with additional layers (e.g., layers 12, 14, 16).

In some embodiments, the manufacturing system 36 may include a control system 78 that controls the manufacturing system 36. The control system 78 includes a controller 80 with one or more processors 82 that execute instructions stored on one or more memories 84 to control various components (e.g., pumps, mixers, valves, etc.) that form part of the first and second chemical lines 40, 42. In operation, the controller 80 may receive feedback from sensors and/or flowmeters to control formation and mixing of the first and second mixtures 44, 46.

For example, the manufacturing system 36 may include one or sensors 86 that monitor the mixing of the polyol 50, catalysts 56, viscosity additive 58, and blowing agent 60 and/or whether the polyol 50, catalysts 56, viscosity additive 58, and blowing agent 60 are within threshold ratios. If the proportions of polyol 50, blowing agent 60, catalysts 56, and viscosity additive 58 are outside of the threshold ratios, the controller 80 executes instructions with the processor 82 to control the pump 52, pump 62, valve 88, and/or valve 90.

Based on the measured amounts of polyol 50, catalysts 56, viscosity additive 58, and blowing agent 60, the controller 80 may control the amount of filler 38 that enters the mixer 64. For example, the controller 80 may control a valve 92 to increase and decrease the amount of filler 38 that enters the mixer 64. In some embodiments, the control system 78 may include a level sensor that detects the percentages of liquid and filler in the first mixture 44 to ensure the desired ratio of polyol 50, catalysts 56, viscosity additive 58 to filler 38 in the first mixture 44.

The second chemical line 42 may also include one or more sensors 166 that measure the amount of isocyanate 73 and viscosity additive 58 in the second mixture 46. If the ratios of isocyanate 73 and viscosity additive 58 are incorrect the controller 80 executes instructions with the processor 82 to increase and/or decrease the flow of the isocyanate 73 with the pump 160 and/or controls the valve 162 to increase and/or decrease the amount of viscosity additive 58 entering the mixer 190 (e.g., solid-liquid mixer, eductor mixer). Based on the measured amounts of isocyanate 73 and viscosity additive 58, the controller 80 controls the amount of filler 38 that enters the mixer 190. For example, the controller 80 may control a valve 192 to increase and decrease the amount of filler 38 that enters the mixer 190. In some embodiments, the control system 78 may include a level sensor that detects the percentages of liquid and filler in the second mixture 46 to ensure the desired ratio of isocyanate 73, viscosity additive 58, and filler 38 in the second mixture 46.

In some embodiments, the manufacturing system 36 may control the ratio of the first mixture 44 to the second mixture 46 in the mixing head 48 using flow meters 94, 96. As illustrated, the flow meter 94 enables measurement of the first mixture 44 entering the mixing head 48 and the flow meter 96 enables measurement of the second mixture 46 entering the mixing head 48. In operation, the controller 80 communicates with the flow meters 94, 96 and controls the pumps 68 and 74 in response to measured flow rates of the first and second mixtures 44, 46 entering the mixing head 48.

What is claimed is:

1. A high-density foam cover board, comprising:
a high-density foam layer, wherein the high-density foam layer comprises polyurethane, polyisocyanurate, a filler, and a viscosity additive;
wherein the high-density foam layer has a density greater than 3 pounds per cubic foot.

2. The high-density foam cover board of claim 1, wherein the filler comprises at least one of inorganic powder, organic powder, granules, platelets, and fibers.

3. The high-density foam cover board of claim 1, wherein the filler comprises up to 50 percent by weight of a total weight of the high-density foam layer.

4. The high-density foam cover board of claim 1, wherein viscosity additive comprises a non-volatile liquid with viscosities less than 1000 centipoise (cps).

5. The high-density foam cover board of claim 1, wherein the viscosity additive comprises up to 10 percent by weight of a total weight of the high-density foam layer.

6. The high-density foam cover board of claim 1, comprising one or more protective layers coupled to the high-density foam layer.

7. The high-density foam cover board of claim 6, wherein the one or more protective layers comprises a coated glass facer.

8. A manufacturing system for making a foam cover board, comprising:
a first chemical line that delivers a first mixture to a mixing head, the first chemical line comprising:
a polyol source;
a first mixer that mixes polyol from the polyol source with one or more catalysts and a blowing agent;
a first pump fluidly coupled to the first mixer and configured to pump the first mixture to the mixing head;
a second chemical line delivers a second mixture to the mixing head, the second chemical line comprising:
an isocyanate source;
a second pump coupled to the isocyanate source and configured to pump isocyanate from the isocyanate source to the mixing head;
a filler source; and
wherein the manufacturing system combines filler from the filler source with the first mixture and the second mixture to form the foam cover board.

9. The system of claim 8, wherein the filler source couples to the first chemical line enabling the filler to be combined with the first mixture upstream from the mixing head.

10. The system of claim 8, wherein the filler source couples to the second chemical line enabling the filler to be combined with the second mixture upstream from the mixing head.

11. The system of claim 8, wherein the filler source couples to the mixing head enabling the filler to be combined with the first and second mixture in the mixing head.

12. The system of claim 8, wherein at least one of the first chemical line and the second chemical line receive a viscosity additive.

13. The system of claim 8, comprising a second mixer that combines the filler with at least one of the first mixture and the second mixture.

14. The system of claim 8, wherein the filler comprises at least one of talc, kaolin, glass dust, mica, carbon black, magnesium hydroxide, gypsum, calcium carbonate, expanded perlite, and glass fibers.

15. The system of claim 8, wherein the foam cover board comprises up to 50 percent by weight of the filler.

16. The system of claim 8, comprising a controller that controls operation of the first pump, the second pump, and the first mixer to control a composition of at least one of the first mixture and the second mixture.

17. A method of making a foam cover board with a filler, comprising:
flowing a first mixture to a mixing head, wherein the first mixture comprises polyol and at least one catalyst;
flowing a second mixture to the mixing head, wherein the second mixture comprises isocyanate;
combining a filler with the first mixture and the second mixture to form a foam cover board.

18. The method of claim 17, wherein combining the filler with the first mixture and the second mixture comprises adding the filler to the first mixture upstream from the mixing head.

19. The method of claim 17, wherein combining the filler with the first mixture and the second mixture comprises adding the filler to the second mixture upstream from the mixing head.

20. The method of claim 17, comprising adding a viscosity additive to at least one of the first mixture and the second mixture.
